(19) United States
(12) Patent Application Publication
(10) Pub. No.: US 2017/0122258 A1
(43) Pub. Date: May 4, 2017

(54) COMBUSTOR OF A LIQUID PROPELLENT MOTOR

(71) Applicant: AVIO S.P.A., I-Roma (IT)

(72) Inventors: Paolo BELLOMI, Roma (IT); Daniele LIUZZI, Latina (IT); Mikhail RUDNYKH, Velletri (IT)

(21) Appl. No.: 15/301,922

(22) PCT Filed: Apr. 9, 2015
(86) PCT No.: PCT/IB2015/052596

§ 371 Date: Oct. 4, 2016

(30) Foreign Application Priority Data
Apr. 9, 2014 (IT) TO2014A000306

(51) Int. Cl. F02K 9/64; F02K 9/97

(52) U.S. Cl. CPC F02K 9/64; F02K 9/972

(57) ABSTRACT

A combustor for a liquid propellent motor has an elongated hollow tubular casing having an inner wall delimiting a combustion chamber for the liquid propellent and an outlet nozzle for the combustion products, and an outer wall, both being coaxial to an axis of the casing; the inner and outer walls being spaced apart from each other in radial direction and delimiting at least one guiding conduit of a cooling fluid therebetween; a plurality of bar-shaped elements extending into the guiding conduit, which form a grid for perturbing the cooling fluid, stiffening the casing and increasing the heat exchange surface; the grid being part of a body made in one piece and of a single material along with the inner and outer walls.

### TECHNICAL FIELD

The present invention relates to a combustor of a liquid propellent motor.

In particular, the present invention relates to a combustor for spacecraft motors of the type comprising a tubular casing elongated along an axis thereof and delimiting a combustion chamber.

The casing comprises a cylindrical portion, in which the combustion of the propellent occurs, and a shaped portion defining a converging-diverging nozzle, in which combustion energy is transformed into kinetic energy, which are mutually aligned along an axis thereof.

### BACKGROUND ART

Known casings are made of different materials, and in particular comprise an inner wall made of metal material with high thermal conductivity, generally a copper alloy, and an outer wall or shell, made of high mechanical strength metal material, e.g. a nickel alloy.

The inner wall, conveniently made by means of mechanical machining, is provided with a plurality of plate-shaped radial baffles which radially extend over the entire length of the casing and delimit a crown of rectilinear or helical channels placed side-by-side and separated from one another by the mentioned baffles. The channels are closed by the outer wall, which is integrally connected in a fluid-tight manner to the free end portion of each baffle by welding or brazing. Thereby, the inner and outer walls delimit a crown of conduits therebetween, which are separated from one another by a respective common baffle of nearly quadrangular section.

The welding of the baffles to the outer wall allows the inner wall to be stiffened so as to confer an adequate mechanical strength against operative loads, mainly of thermal-structural nature, thereto.

The channels thus formed are crossed, in use, by a cooling fluid, conveniently defined by the liquid propellant subsequently introduced into the combustion chamber, to define part of a hydraulic cooling circuit of the casing, and in general to remove part of the heat generated in the combustion chamber. The feeding amount and speed of the cooling fluid are chosen so as to achieve the two-fold purpose of maximizing the structural strength of the inner wall and of extracting the maximum amount of thermal energy from the casing, compatibly with the maximum temperature which can be supported by the inner and outer walls and with the thermal capacities of the cooling fluid utilized.

Although universally used, the known casings of the above-described type are not very satisfactory, especially because they pose limits to increasing the amount of heat which can be removed, whit the cooling fluid being equal, and in practice they do not allow freedom in choosing the combustion chamber geometry.

This mainly derives from the fact that a thermal layering is generated in the conduits, which limits the thermal exchange and thus opposes increasing the amount of removed heat. In other words, the flow of each conduit is a layered flow, and thus the heat transfer approximates a conductive behavior between the various layers which, as known, has a clearly lower efficiency than a merely convective phenomenon.

In addition, the practically rectangular section of the conduits dictated by the geometry of the baffles poses a physical limit to increasing the heat exchange surface. Finally, the known combustors are large in size and heavy.

A known combustor according to patent US2004/012980 consists of a component made of a thermal-structural composite material. Such a part is characterized by a porous wall to the hot gases through which the propellent is introduced into the combustion chamber. Part of the propellent is further directed towards the throat of the combustor to allow it to be cooled. The oxidant is directly introduced into the chamber from the side opposite to the combustor throat.

The thermal protection architecture known from industrial patent FR2776714 is characterized by a partial cooling, where some of the fuel is introduced into the chamber through a perforated thermal barrier and some more of the fuel remains in the convective cooling circuit.

It is worth noting that the two aforementioned patents represent only one of the possible variants for cooling the combustion chambers by means of the wall porosity or of a perforated thermal protection. These types of film cooling are characterized by a reduction of combustion efficiency due to the non-uniformity of the mixture ratio along the whole cross-section of the combustor.

The combustors known from industrial patents US2004/0103639, US2010/0205933 and US208/0264035 are provided with impermeable inner and outer walls. The walls are spaced apart in radial direction and connected by means of plate-shaped baffles which extend in radial direction. Such baffles delimit passage channels for the fluid used for cooling the hot wall on gas side. In some applications, Porous structures or helical ribbons/wires or cooling fluid guiding control surfaces are introduced into the conduits in order to maximize the cooling performance and exclude coolant layering.

It is worth noting that the inner wall of the aforesaid combustors is characterized by a very high thickness, because the filling structures of the conduits are not used as structural reinforcement and for the connection with the outer wall, but are simply accommodated in the channel or are made integral with a thermal process after the insertion. The increase of thickness of the inner wall results in a decrease of thermal exchange towards the cooling conduits and in the increase of the temperature of the hot gas wall, which directly affects the performance of the combustor by causing a limitation in terms of propellent pressure and mixture ratio.

### DISCLOSURE OF INVENTION

It is the object of the present invention to provide a combustor for a liquid propellent motor, the construction features of which allow the above-described problems to be solved in a simple, cost-effective manner, and a high efficiency and reliability combustor of low weight and small dimensions to be implemented.

According to the present invention, a combustor of a liquid propellent motor is provided as claimed in claim 1.

In particular, the present invention is based on a combustion chamber made in one piece and of a single material with a single construction process based on laser fusion starting from material powder. The particular material, used because it has a low thermal conductivity, preferably lower than 30 W/(m K), and a high mechanical strength, preferably greater than 400 MPa, is highly different from the materials used in the prior solutions.

The inner wall is conveniently characterized by a thin liner, conveniently thinner than 0.8 millimeters, supported by a grid or tidy multifunctional reticular structure, the purpose of which is to support the mechanical loads, to support the thermal loads, to increase the cooling efficiency by increasing the ratio of heat exchange surface to coolant passage volume, to destroy the thermal layering inside the channel, and to increase the flow turbulence on different characteristic scales.

The grid forms an integral part of the chamber, of the inner wall or liner and of the outer shell, being constructed at the same time and integrally with said parts.

The grid is preferably designed as a series of wedged, inclined and mutually crossed beams with a smaller thickness than that of possible radial baffles, such to distribute the operative loads along the main force directions. A considerable increase in the number of beams with respect to the number of radial baffles, and thus a considerable increase in the heat exchange surface, is apparent, with the volume of metal occupied by the radial baffles in a traditional configuration being equal. The fluid speed can be modulated according to the density of the beams and to the size of the fluid passage channel. The grid allows to operate directly on the convective heat exchange capacity of the fluid by acting on the direction of the fluid itself and on the increase of vorticity.

The first effect is to eliminate the thermal layering in the channel by forcing the fluid to travel along a path non-parallel to the hot surface, but forced from the outer surface of the cold shell towards the inner part of the hot liner, within one or two characteristic lengths of the fluid phenomenon. Thereby, a macroscopic mixing movement, which tends to uniform the fluid temperature along the channel, is created. Such an effect is obtained with an appropriate geometry of the aerodynamic profile-shaped cross-section of the beams, for example. The fluid can be guided along the desired direction (FIG. 5) with an appropriate orientation of the profiles.

The tapered shape of the profiles further allows the shape losses in the fluid to be minimized, and their increase due to the greater blocking is compensated for by increasing the size of the channel and thus with a reduction of the fluid speed. The second effect is to increase the vorticity of the fluid, and thus increase quantitatively the heat exchange by convection, thus obtaining a better mixing of the fluid on micro-scale in connection with the characteristic turbulent dimension. The vorticity increase is caused by the perturbation of the fluid induced by the presence of the grid itself, which causes a turbulence increase downstream of each profile or beam, and thus a heat exchange increase on the surface. The level of vorticity can be also modulated, by managing the relative orientation between tapered profile and flow direction, i.e. the incidence. The grid has the purpose of considerably increasing the heat exchange by convection on cold side and of preserving the structural integrity of the chamber while preserving the capacity of supporting the operative loads by connecting the outer shell to the inner liner.

A variant of the present invention uses the grid on only one or more stretches of the conduit and only where the thermal cooling requirement is higher. In particular, if the extent of the thermal flow caused by the hot gases is low, the technical solution of drastically reducing the thickness of the liner may be sufficient to ensure the thermal balance despite the decrease of thermal conductivity of the material. Therefore, combustion chambers which have a mixed architecture, with a stretch made following a traditional configuration and a stretch made following a reticular configuration according to the present invention, may be created. In all cases, the camera thus designed can be made in one piece and no subsequent construction processes are needed.

### BRIEF DESCRIPTION OF THE DRAWINGS

The invention will now be described with reference to the accompanying drawings which show a non-limitative embodiment thereof, in which:

FIG. 1 diagrammatically shows in blocks and semi-radial section, with parts removed for clarity, a liquid propellent motor provided with a preferred embodiment of the combustor according to the dictates of the present invention;

FIG. 2 is a diagrammatic section taken along line II-II in FIG. 1;

FIG. 3 is diagrammatic, perspective partial view of a portion of a detail in FIGS. 1 and 2;

FIGS. 4 and 5 are a top view and a side view, respectively, of the detail in FIG. 3;

FIG. 6 shows a variant of a detail in FIGS. 1 and 2;

FIG. 7 shows a further variant of a detail in FIGS. 1 and 2 in section and on enlarged scale; and

FIGS. 8A and 8B are different sections on greatly enlarged scale taken according to line VIII-VIII in FIG. 3.

### BEST MODE FOR CARRYING OUT THE INVENTION

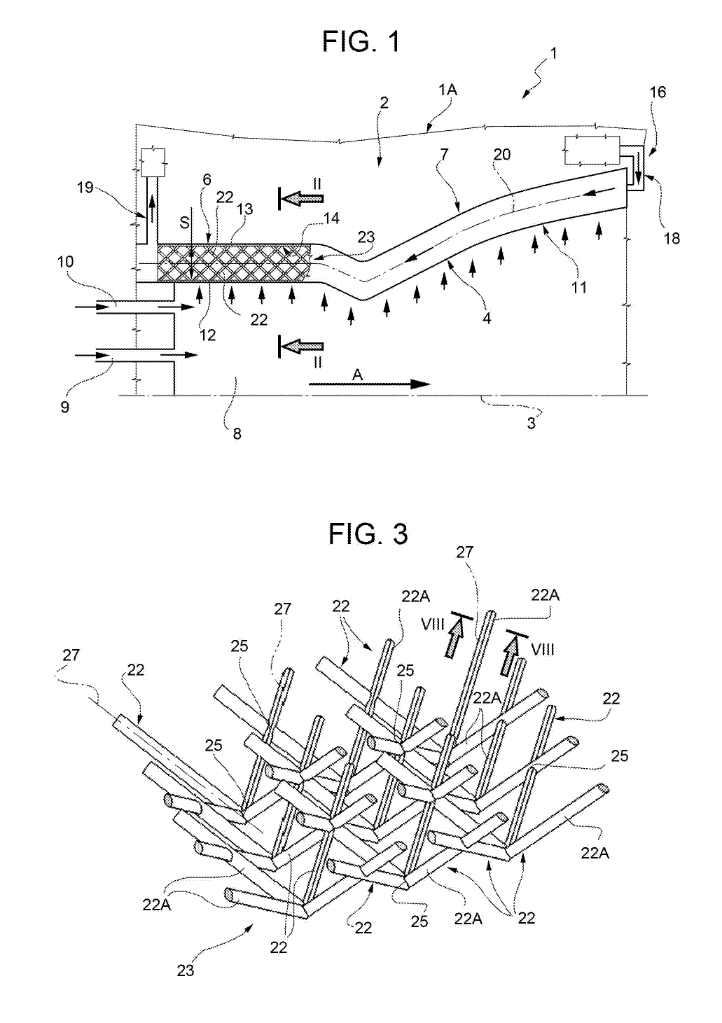

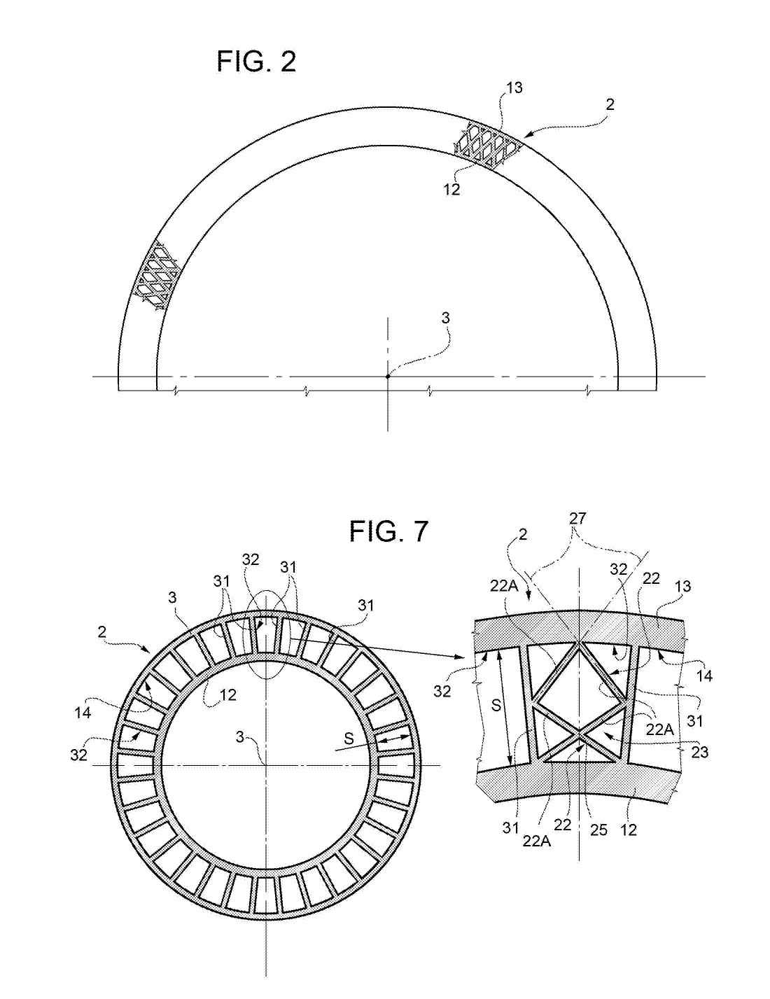

In FIG. 1, reference numeral 1 indicates, as a whole and with parts removed for clarity, a liquid propellent spacecraft motor.

Motor 1 comprises a thrust chamber 1A, comprising, in turn, an elongated combustor 2 having its own axis 3. Combustor 2 comprises a tubular metal casing 4. Casing 4 is shaped coaxially to axis 3 and, in the feeding direction of the combustion product indicated with arrow A in FIG. 1, comprises a tubular portion 6 with a cylindrical generating line and a shaped tubular portion 7, both coaxial to axis 3 and stably connected to each other in a fluid-tight manner (FIG. 1).

The tubular portion 6 laterally delimits a combustion chamber 8, in which a feeding conduit 9 of the liquid propellent and a feeding conduit 10 of the combustion supporting fluid, forming part of the thrust chamber 1A, lead.

Instead, the shaped tubular portion 7 delimits a converging-diverging nozzle 11, known per se, through which the combustion products generated in the combustion chamber 8 pass.

Again with reference to FIG. 1, casing 4 is a hollow casing and comprises an inner wall 12 defining the geometry of the combustion chamber 8 and of the nozzle 11, and an outer wall 13, both being coaxial to axis 3.

The walls 12 and 13 are blind walls impermeable to liquid or gaseous substances, are spaced apart from each other in radial direction, and delimit a sealed annular conduit 14 therebetween, which longitudinally extends between the inlet of the propellent/combustion supporting fluid in the combustion chamber 8 and the outlet of the combustion products from nozzle 11.

Conduit 14, which in the particular example described has a nearly constant thickness S along axis 3, forms part of a cooling circuit of combustor 2, indicated as a whole by reference numeral 16 in FIG. 1.

The cooling circuit 16 further comprises an inlet manifold 18 for introducing a cooling fluid into conduit 14, conveniently the same liquid propellent then sent to the combustion chamber 8 or another cooling fluid, and an outlet manifold 19 adapted to receive the cooling fluid from conduit 14. Between the two manifolds 18 and 19, conduit 14 guides the cooling fluid in a feeding direction indicated by reference numeral 20 in FIG. 1 and substantially parallel to a generating line of the inner wall 12.

In the particular example described, the cooling fluid moves in the direction opposite to the displacement of the combustion products. Alternatively, according to a different embodiment, the cooling fluid moves in a direction agreeing with the displacement of the combustion products.

Again with reference to FIG. 1, conduit 14 accommodates a plurality of bar-shaped elongated elements 22 which form part of casing 4 and extend between the walls 12 and 13. The elongated elements 22 are stably connected to the walls 12, 13 and are elongated in respective direction transverse to the feeding direction 20 of the cooling fluid in conduit 14.

The elongated elements 22 define a homogenous, narrow-mesh grid 23 for perturbing the cooling fluid which passes in direction 20 having the function of generating a predetermined turbulence in the cooling fluid itself in each zone of conduit 14.

In the particular example described, grid 23 has a plurality of nodes 25 for connecting together the bar-shaped elements 22. Conveniently, the nodes 25 are uniformly distributed inside conduit 14.

Alternatively, the distribution of the nodes 25 varies from one zone to the other of conduit 14 in order to make a different perturbation of the cooling fluid, and therefore a different removal of the heat through casing 4. The different distribution of the nodes 25 is obtained by varying the geometry, distribution or orientation of the elongated elements 22 in conduit 14.

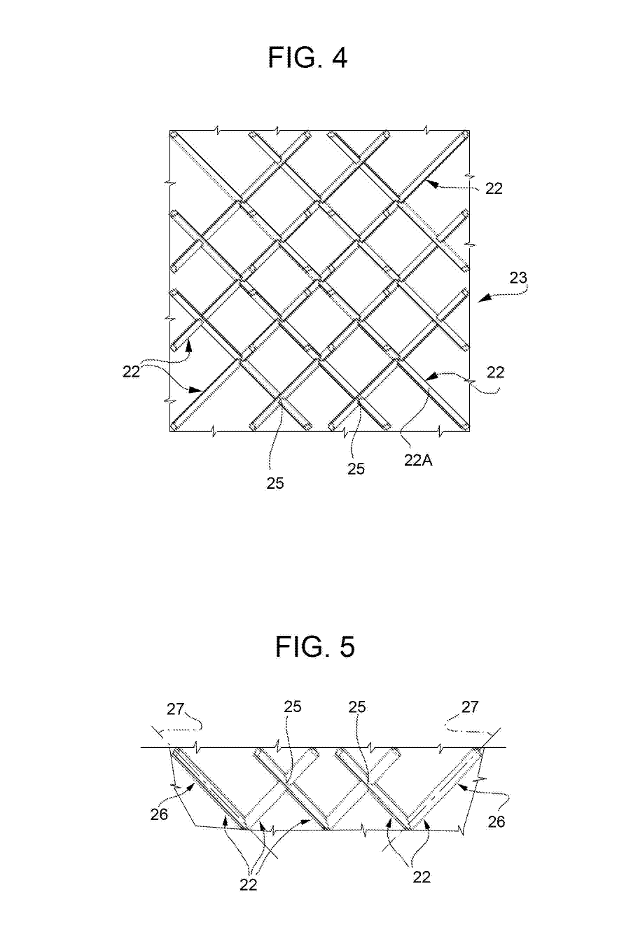

Conveniently, the elongated members 22 have mutually consecutive rectilinear stretches 22A, each of which, in the particular example described, is defined by a piece of bar and leads to at least one node 25, as shown in FIGS. 3, 4 and 5 which depict a portion of grid 23.

In the particular example described, each rectilinear stretch 22A is butt-joined to a subsequent stretch 22A and is laterally delimited by an outer surface 26 having a rectilinear generating line parallel to a longitudinal extension axis 27 of the respective stretch 22A.

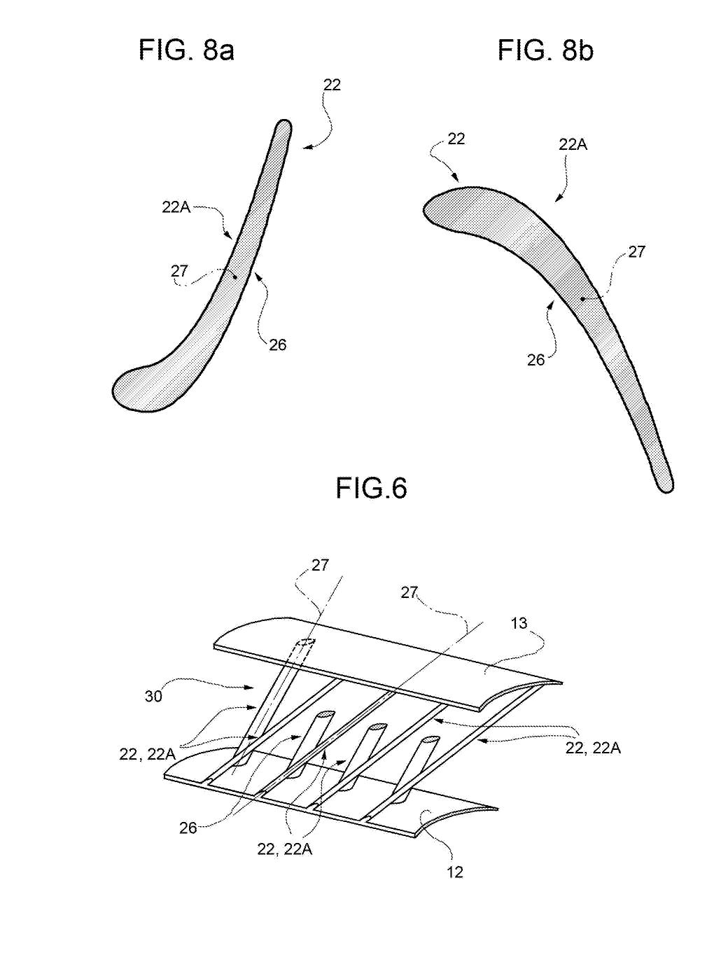

Each stretch 22A also has its own cross-section which is orthogonal to the respective longitudinal axis 27 being either circular or oblong in shape, either tapered or not at least at one of its ends, or having at least one curved portion, as shown in FIGS. 8A and 8B. In the latter case, each stretch 22A is shaped as a blade of a bladed stator crown of a traditional hydraulic machine. The sections of the various elongated stretches 22A are geometrically and dimensionally either equal or different from one zone to the other of conduit 14 or from one elongated element 22 to that adjacent thereto. Similarly, the lengths of the stretches 22A or of the elongated elements 22 are either equal or different from one zone to the other of conduit 14. According to a variant, at least some of the stretches 22A or of the elongated elements 22 are plate-shaped with rounded or non-rounded edges of the type shown in FIGS. 8a and 8b. Alternatively, the cross-section of the stretches 22A or of the elongated elements 22 may be either rectangular or rhomboidal. In the variant shown in FIG. 6, the elongated elements 22 comprise a single rectilinear stretch 22A which extends between the walls 12 and 13, in order to define a grid 30 which is simplified or has a larger mesh than that of grid 23. In such an embodiment, the elongated elements 22 extends again in directions forming an angle different from zero, in a mutual manner and with the feeding direction 20, and in positions which are transversely spaced apart, i.e. without contact points or so as to be arranged tangent to one another. Also in this case, the elongated elements 22 may have either a different distribution or geometrically or dimensionally different cross-sections as their position varies inside conduit 14, as described above.

According to a further variant, inside the conduit, narrow mesh grids 23 are present in some zones and large mesh grids 30 are present in other zones.

In the further variant shown in FIG. 7, the walls 12 and 13 are connected together by means of a plurality of plate-shaped radial baffles 31, which are also integrally connected to the walls 12 and 13 and extend along axis 3, not necessarily parallel to the axis 3 itself and along helical paths, for example. The radial baffles 34 divide conduit 14 into a plurality of smaller longitudinal conduits 32 placed side-by-side for guiding the cooling fluid. A perturbation grid of the fluid threads is provided within each smaller channel 32, which in this case is a narrow mesh grid 23. Alternatively, the smaller channels 32 accommodate a large mesh grid 30 or a combination of narrow and large mesh grids over at least one stretch. The channels 32 may have stretches free from grids interlayered or not with gridded stretches.

In general, the placement, geometry and size of each elongated stretch 22A or of an elongated element 22 is determined to obtain a given turbulence of the cooling fluid inside conduit 14 and a desired heat exchange surface, on one hand, and to confer shape stability to casing 4 regardless of the working temperatures and of the mechanical stresses to which the casing 14 itself is subjected, on the other.

Regardless of the type of grid used, the arrangement or section of the elongated elements 22 defining the grid itself, the walls 12 and 13 are again stably connected to the ends of the respective elongated elements 22, which thus behave as wedged beams on the walls 12 and 13 themselves. When the elongated elements 22 lead into a node, in addition to be wedged at their opposite ends, they also have intermediate portions wedged with respect to the other adjacent elongated elements 22.

Regardless of the distribution or geometry of the elongated elements 22, the walls 12 and 13 and the elongated elements 22 themselves are made of the same metal material, e.g. steel, in general nickel alloys or other equivalent metal materials, and the elongated elements 22 along with the walls 12 and 13 form part of a homogenous monolithic body made in one piece, preferably by means of the technique currently known as “Additive Layer Manufacturing”. If present, baffles 31 also form part of the body made in one piece as shown in FIG. 7.

Alternatively, one or both opposite ends of each elongated element 22 or of the baffles 31, when present, are stably connected to the respective wall 12, 13, e.g. by means of brazing.

In this case, different materials may be used to make one or both walls 12, 13 or elongated elements 22.

From the above, it is apparent that regardless of the process used to make the grid between the walls 12 and 13 and regardless of the type of grid or distribution of the grids along and inside conduit 14, or even regardless of the geometry or orientation of the elongation elements 22, each of the elongated elements 22 themselves triggers a localized turbulence and a predefined vorticity in the cooling fluid. Such a vorticity drastically reduces up to completely canceling out the thermal layering present in the conduits of the existing solutions, thus allowing the amount of removed heat to be increased, again as compared to the known solutions, with the cooling fluid features being equal.

More in detail, the elongated elements 22 force the cooling fluid to follow paths which are not parallel to wall 12, i.e. to the hot surface of casing 4, but are directed from the outer wall 13 or cold wall towards the inner wall 12. Thereby, a macroscopic mixing movement is created, which tends to uniform the temperature of the fluid along conduit 14 and in radial direction. By managing the orientation of the elongated elements 22 with respect to the feeding direction of the cooling fluid it is then possible to obtain a controlled detachment of the fluid vein on the elongated elements 22.

The presence of grids between the walls 12 and 13 then allows the operative loads to be distributed along main preferential force directions, and thus geometrically stable combustors to be obtained. In addition, as compared to the known solutions, the presence of structural grids inside conduit 14 allows the thickness of the inner wall to be reduced, and casings of lower weight and smaller dimensions to be provided in general. The above is substantially due to the construction of casing 4 which is a monolithic body made in one piece by using a single metal material.

Furthermore, the described grid solutions ensure greater freedom in defining the geometry of the combustion chamber.

Moreover, the presence of the grids 23, 30, with the volume of metal arranged between the walls 12 and 13 being equal, allows a considerable increase in heat exchange surface to be obtained. The speed of the cooling fluid can be modulated, and in general can be controlled, according to the density of the elongated elements 22 and to the size of the conduit 14 where the cooling fluid passes.

Finally, as compared to the known solutions described, the solution according to present invention provides the possibility to obtain a high effective combustion while avoiding the use of a permeable inner wall.

Again, with respect to the above-described known solutions, the inner wall 12 may have a very small thickness, and conveniently a thickness smaller than 0.8 millimeters.

The inner wall thickness may be brought to these low values because the elongated elements 22 define a structural reinforcement, either alone and along with the outer wall.

It is then apparent that the structural strength of casing 4 is much greater than that of the current known solutions, namely because the inner and outer walls and the inner grid defined by the elements 22 are manufactured in one monolithic piece made of a single material characterized by high mechanical strength.

The particular manufacturing method described then allows any type of grid to be implemented without any limitation, unlike the known solutions in which the process is always very constrained.

From the above, it is apparent that modifications and variants may be made to the described combustor 2 without departing from the scope of protection defined by the independent claim. In particular, it is apparent that the bar-shaped elongated elements 22 may be made by means of a different process and may have, for example, curved or plate-shaped stretches which inevitably lead to the formation of different grids from those indicated and shown in the accompanying figures.

Finally, conduit 14 may have stretches free from grids interlayered or not with gridded stretches which are equal to or different from one another.

1-13. (canceled)

14. A combustor of a liquid propellent motor, the combustor comprising:
an elongated hollow tubular casing having an axis, the elongated hollow tubular casing including:
an inner wall coaxial to the axis, the inner wall delimiting a combustion chamber for the liquid propellent and an outlet nozzle for the combustion products, the inner wall having a thickness of less than about 0.8 millimeters; and
an outer wall coaxial to the axis;
wherein the inner and outer walls are spaced from each other in a radial direction; the inner and outer walls delimiting at least one sealed guiding conduit for a cooling fluid therebetween in a feeding direction;
turbulence generating means accommodated in the at least one sealed guiding conduit and intercepted by the cooling fluid;
wherein the turbulence generating means include a plurality of bar-shaped elongated elements extending transversely to the radial direction, the turbulence generating means having end portions that are integrally connected to the inner wall and to the outer wall, thus forming part of a reinforcement of the inner wall;
wherein the inner wall, the outer wall, and the plurality of bar-shaped elongated elements form parts of a substantially homogenous monolithic body, the substantially homogenous monolithic body has been made in one piece and of the same metal material by Additive Layer Manufacturing starting from powder of the metal material.

15. The combustor according to claim 14, wherein at least some of the plurality of bar-shaped elongated elements have at least one rectilinear bar stretch.

16. The combustor according to claim 15, wherein at least some of the rectilinear bar stretches are inclined with respect to one another and with respect to the axis.

17. The combustor according to claim 14, wherein at least some of the plurality of bar-shaped elongated elements have a cross-section that is circular, oblong, rectangular, or rhomboidal.

18. The combustor according to claim 14, wherein at least some of the plurality of bar-shaped elongated elements are tapered at least at one end thereof.

19. The combustor according to claim 14, wherein at least some of the plurality of bar-shaped elongated elements have a cross-section that is at least partly arched.

20. The combustor according to claim 14, wherein at least two of the plurality of bar-shaped elongated elements intersect each other in at least one node.

21. The combustor according to claim 14, wherein at least two of the plurality of bar-shaped elongated elements are tangent to each other at least one point.

22. The combustor according to claim 14, wherein at least some of the plurality of bar-shaped elongated elements intersect one another to form a first grid having a plurality of nodes.

23. The combustor according to claim 22, wherein the first grid is a substantially homogeneous grid along at least part of the at least one sealed guiding conduit.

24. The combustor according to claim 22, wherein at least some of the plurality of bar-shaped elongated elements intersect one another to form a second grid having a plurality of nodes and a different mesh from the first grid.

25. The combustor according to claim 14, further comprising:
at least one plate-shaped radial baffle extending between the inner and outer walls and being integrally connected to the inner and outer walls to delimit two of the at least one sealed guiding conduit;
wherein each of the two of the at least one sealed guiding conduit accommodating respective the turbulence generating means that are either equal or different;
wherein the inner and outer walls, the baffles, and the turbulence generating means forming part of a body made in one piece and of a single metal material.

26. The combustor according to claim 14, wherein the single metal material has a mechanical strength that is higher than 400 MPa.

27. The combustor according to claim 14, wherein the single metal material has a thermal conductivity that is higher than 30 W/(m K).

28. A combustor of a liquid propellent motor, the combustor comprising:
an elongated hollow tubular casing having an axis, the elongated hollow tubular casing including:
an inner wall coaxial to the axis, the inner wall defining a combustion chamber for the liquid propellent and an outlet nozzle for the combustion products, the inner wall having a thickness of less than about 0.8 millimeters; and
an outer wall coaxial to the axis;
wherein the inner and outer walls are spaced from each other in a radial direction; the inner and outer walls defining at least one sealed guiding conduit for a cooling fluid therebetween in a feeding direction;
a plurality of bar-shaped elongated elements disposed in the at least one sealed guiding conduit for interception by the cooling fluid, the plurality of bar-shaped elongated elements extending transversely to the radial direction, the plurality of bar-shaped elongated elements having end portions that are integrally connected to the inner wall and to the outer wall, thus forming part of a reinforcement of the inner wall;
wherein the inner wall, the outer wall, and the plurality of bar-shaped elongated elements form parts of a substantially homogenous monolithic body, the substantially homogenous monolithic body has been made in one piece and of the same metal material by Additive Layer Manufacturing starting from powder of the metal material.

29. The combustor according to claim 28, wherein at least some of the plurality of bar-shaped elongated elements have at least one rectilinear bar stretch.

30. The combustor according to claim 28, wherein at least some of the plurality of bar-shaped elongated elements have a cross-section that is circular, oblong, rectangular, rhomboidal, or at least partly arched.

31. The combustor according to claim 28, wherein at least some of the plurality of bar-shaped elongated elements are tapered at least at one end thereof.

32. The combustor according to claim 28, wherein at least some of the plurality of bar-shaped elongated elements intersect one another to form a first grid having a plurality of nodes.

33. The combustor according to claim 32, wherein at least some of the plurality of bar-shaped elongated elements intersect one another to form a second grid having a plurality of nodes and a different mesh from the first grid.
